(19) United States
(12) Patent Application Publication
(10) Pub. No.: US 2025/0100514 A1
(43) Pub. Date: Mar. 27, 2025

(54) SENSOR CLEANING SYSTEM AND METHOD

(71) Applicant: International Truck Intellectual Property Company, LLC, Lisle, IL (US)

(72) Inventor: Robert M. Tourville, Aurora, IL (US)

(73) Assignee: International Truck Intellectual Property Company, LLC, Lisle, IL (US)

(21) Appl. No.: 18/371,047

(22) Filed: Sep. 21, 2023

(51) Int. Cl. B60S 1/56; B08B 3/02; B08B 5/02; B08B 7/04

(52) U.S. Cl. CPC B60S 1/56; B08B 3/02; B08B 5/02; B08B 7/04

(57) ABSTRACT

A sensor cleaning system includes a shutter having a first position outside of a field of view of the sensor and a second position blocking the field of view of the sensor. A solvent nozzle is disposed on a side of the shutter facing the sensor and configured to spray solvent onto the sensor. An air nozzle is disposed on the side of the shutter facing the sensor and configured to spray air onto the sensor.

### FIELD OF THE INVENTION

The present disclosure relates generally to a system and method for cleaning debris from a sensor mounted on a vehicle surface, and more particularly to a system and method for determining if the sensor requires cleaning, and if so, cleaning debris from the sensor with cleaning solvent, allowing the cleaning solvent to drain away, and drying the sensor.

### BACKGROUND

Sensors are commonly disposed on surfaces of modern vehicles, and are becoming more sensitive for collecting data on the vehicle surroundings for use in critical tasks, for example, including autonomous driving modes. It is crucial that such sensors function accurately without being fouled by debris coating the sensor and interfering with optimum sensing. A need therefore exists for a robust and reliable cleaning system that can clean vehicle mounted sensors in any driving environment. It would be useful if such a cleaning system could check the cleanliness status of the sensors to determine if cleaning is necessary.

### SUMMARY OF THE INVENTION

In one aspect of the invention, a sensor cleaning system comprises a shutter having a first position outside of a field of view of the sensor and a second position blocking the field of view of the sensor. A solvent nozzle is disposed on a side of the shutter facing the sensor and configured to spray solvent onto the sensor. An air nozzle is disposed on the side of the shutter facing the sensor and configured to spray air onto the sensor.

In another aspect of the invention, a sensor cleaning system comprises a shutter having a first position outside of a field of view of the sensor and a second position blocking the field of view of the sensor. A solvent nozzle is disposed on a side of the shutter facing the sensor and configured to spray solvent onto the sensor. An air nozzle is disposed on the side of the shutter facing the sensor and configured to spray air onto the sensor. The shutter is configured to move back and forth between the first and second positions, wherein an edge of the shutter moves across the field of view of the sensor when the shutter moves from the first position to the second position, and wherein the solvent and air nozzles are proximate to the edge of the shutter.

In a further aspect of the invention, a sensor cleaning system comprises a shutter having a first position outside of a field of view of the sensor and a second position blocking the field of view of the sensor. A solvent nozzle is disposed on a side of the shutter facing the sensor and configured to spray solvent onto the sensor. An air nozzle is disposed on the side of the shutter facing the sensor and configured to spray air onto the sensor. The shutter is configured to move back and forth between the first and second positions, wherein an edge of the shutter moves across the field of view of the sensor when the shutter moves from the first position to the second position, and wherein the solvent and air nozzles are proximate to the edge of the shutter. The shutter in the second position is spaced from the sensor to provide a debris drainage gap therebetween.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 is a schematic diagram of a sensor cleaning system according to an embodiment;

FIG. 2 is a schematic diagram of a side of an exemplary shutter facing the sensor according to an embodiment;

FIG. 3A is a schematic diagram of the sensor cleaning system showing the air nozzle spraying with the shutter in the first position, A, according to an embodiment;

FIG. 3B is a schematic diagram of the sensor cleaning system showing the air nozzle spraying with the shutter in intermediate position, B, according to an embodiment;

FIG. 3C is a schematic diagram of the sensor cleaning system showing the air nozzle spraying with the shutter in intermediate position, C, according to an embodiment;

FIG. 3D is a schematic diagram of the sensor cleaning system showing the air nozzle spraying with the shutter in the second position, D, according to an embodiment;

FIG. 4A is a schematic diagram of the sensor cleaning system showing the solvent nozzle spraying with the shutter in the second position, D, according to an embodiment;

FIG. 4B is a schematic diagram of the sensor cleaning system showing the solvent nozzle spraying with the shutter in intermediate position, C, according to an embodiment;

FIG. 4C is a schematic diagram of the sensor cleaning system showing the solvent nozzle spraying with the shutter in intermediate position, B, according to an embodiment;

FIG. 4D is a schematic diagram of the sensor cleaning system showing the solvent nozzle spraying with the shutter in the first position, A, according to an embodiment; and

FIG. 5 is a block diagram of the steps in an exemplary method of operation of a sensor cleaning system according to an embodiment of the invention.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

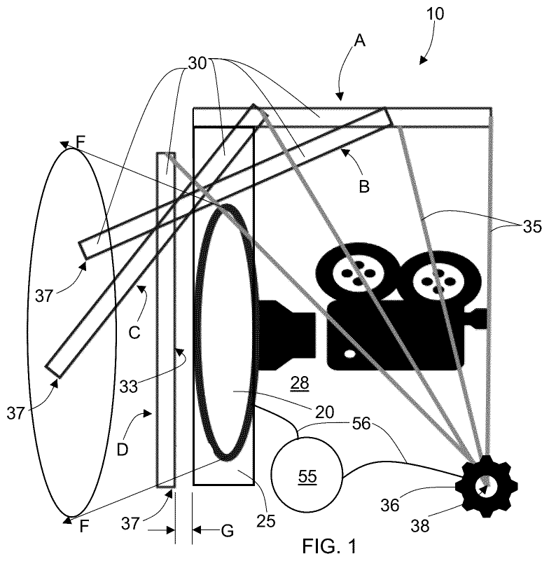

Referring to FIG. 1, an embodiment of an exemplary sensor cleaning system (SCS) 10 includes a sensor 20 having a field of view as represented by the ellipse bounded by the arrows labeled F. In an embodiment the SCS 10 includes a shutter 30 illustrated in four positions in FIG. 1. In an embodiment the shutter 30 has a first position, A, outside of the field of view, F, of the sensor 20 and a second position, D, blocking the field of view, F, of the sensor 20. In an embodiment the shutter 30 when disposed in the second position D is spaced from the sensor 20 to provide a debris drainage gap, G, therebetween. In an embodiment the sensor 20 is disposed on a vehicle body surface 25 and the shutter 30 is attached to the vehicle body 28 proximate the sensor 20.

In an embodiment the sensor 20 is an optical sensor, for example, a video camera. In other embodiments the sensor 20 is a light direction and ranging (LIDAR) sensor. In further embodiments the sensor 20 is a radio detection and ranging (RADAR) sensor, an infrared sensor, a sonic sensor, or any sort of sensor for which debris coated thereon causes a performance decrease.

In an embodiment the shutter 30 has a side 33 that faces the sensor 20. In an embodiment the shutter 30 is configured to move back and forth between the first position A and the second position D via two intermediate positions (shown in FIG. 1 at B and C) that are not stopping positions, but that are included to illustrate the path of rotation of the shutter 30 from first position A to second position D and back. In an embodiment, an edge 37 of the shutter 30 moves across the field of view F of the sensor 20 when the shutter 30 moves from the first position A to the second position D.

In an embodiment the shutter 30 is attached by one or more arms 35 that rotate relative to the body 28 to push the shutter 30 out of the body and over the sensor 20. In an embodiment the shutter 30 is rotatably attached to the vehicle body 28 proximate the sensor 20 by the one or more arms 35. In an embodiment the shutter 30 is recessed into the vehicle body 28 in the first position A.

In an embodiment the one or more arms 35 are driven to rotate to push the shutter 30 from position A to position D and back, for example, by a motor 36 that drives the one or more arms 35, for example, around a pin or axle 38. In an embodiment the one or more arms 35 are attached to the shutter 30 via a flexible link or along a pin or other connector that allows the shutter to rotate around the flexible link so that the angle between the one or more arms 35 and the shutter can change as the shutter 30 moves from position A to position D.

In an embodiment, a controller or user interface 55 is in electrical communication with the sensor 20 and the motor 36. In an embodiment the controller or user interface 55 is in electrical communication with the sensor 20 and the motor 36 via a wired connection, for example, via wires 56, but in other embodiments the electrical communication can be wireless.

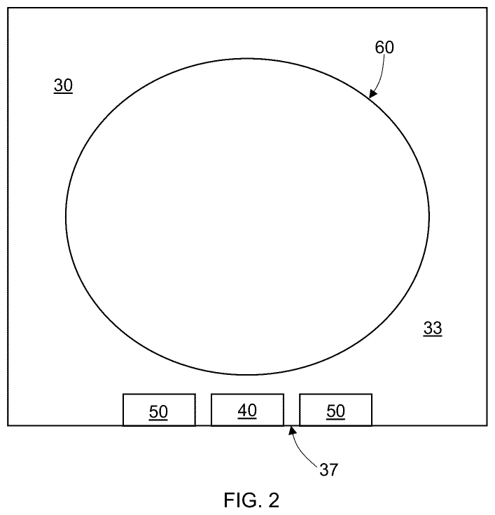

Referring to FIG. 2, in an embodiment the shutter 30 includes at least one solvent nozzle 40 disposed on the side 33 of the shutter 30 facing the sensor 20 and configured to spray solvent onto the sensor 20. In an embodiment the shutter 30 includes at least one an air nozzle 50 disposed on the side 33 of the shutter 30 facing the sensor 20 and configured to spray air onto the sensor 20. In an embodiment the solvent 40 and air 50 nozzles are proximate to the edge 37 of the shutter 30. In an embodiment the shutter 30 comprises a calibration mark 60 disposed on the side 33 of the shutter 30 facing the sensor 20. The calibration mark 60 is illustrated as a simple elliptical feature, but in other embodiments the calibration mark 60 can be any shape as needed or desired for image comparison purposes required for calibration.

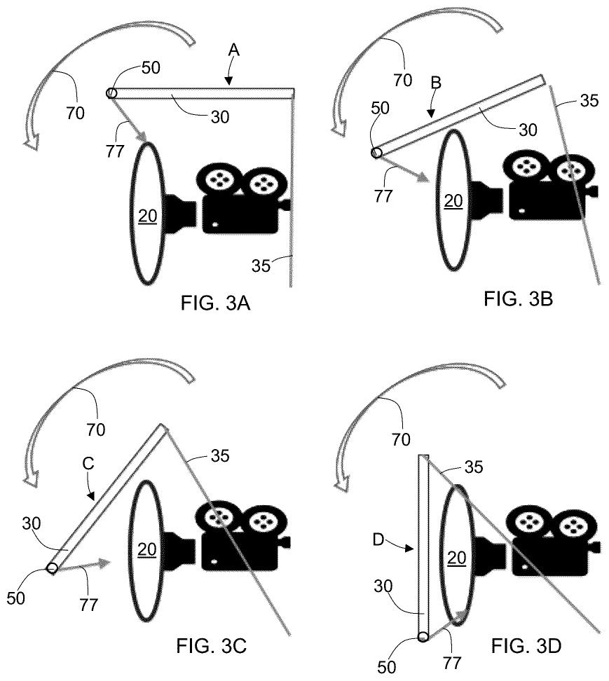

Referring now to FIGS. 3A-3D, in an embodiment the shutter 30 is configured to move between the first position A and the second position D, as indicated by arrow 70. In an embodiment the shutter 30 occupies a home position at position A and a closed position at position D. The air nozzle 50 is configured to spray air, as indicated by the arrow 77, on the sensor 20 while the shutter 30 moves from the first position A to the second position D. In an embodiment as shown in FIG. 3D, the air nozzle 50 is configured to spray air, as indicated by the arrow 77, on the sensor 20 while the shutter 30 is in the second position D.

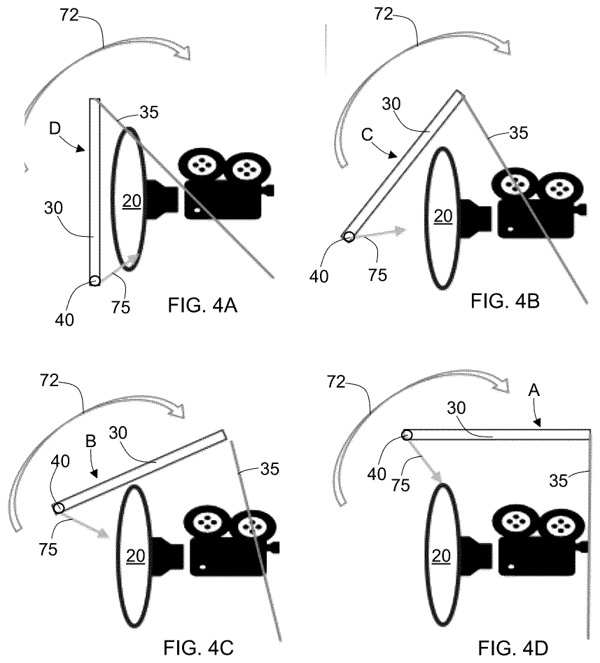

Referring now to FIGS. 4A-4D, in an embodiment the shutter 30 is configured to move between the second position D and the first position A, as indicated by arrow 72. In an embodiment the solvent nozzle 40 is configured to spray solvent, as indicated by the arrow 75, on the sensor 20 while the shutter 30 moves from the second position D to the first position A. In an embodiment as shown in FIG. 4A, the solvent nozzle 40 is configured to spray solvent, as indicated by the arrow 75, on the sensor 20 while the shutter 30 is in the second position D.

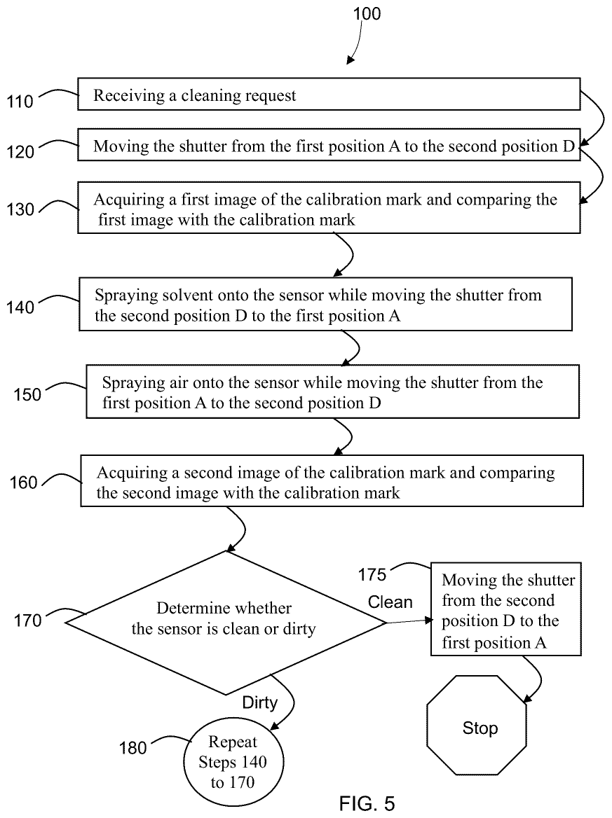

Referring now to FIGS. 1-5, in an embodiment a method 100 for applying the SCS 10 begins at step 110 wherein a cleaning request is received from the controller 55 or manually triggered by a user via the user interface 55. In an embodiment, the controller 55 periodically sends cleaning requests to the SCS 10, where the frequency of the requests can be based on a predetermined schedule or based upon other inputs or factors. In an embodiment the SCS 10 includes the option of allowing a user to make a cleaning request via the user interface 55. In an embodiment, at step 120 the shutter 30 is moved from the first or home position A to the second or closed position D.

In an embodiment, at step 130 a first image of the calibration mark 60 is acquired with the sensor 20, and the first image is compared with a stored image of the calibration mark 60. This first image acquisition and comparison of the first image with the stored image of the calibration mark 60 are made before any cleaning steps, and are useful for determining the cleaning efficiency of the SCS 10. For example, the first image is compared to a 100% clean image (which would be a complete unobstructed calibration mark 60). Then, later in the method 100 after a cleaning step and after a second image is acquired, the second image is compared to a 100% clean image. The results of the comparisons of the first and second acquired images with the 100% clean image (before and after cleaning) can help to determine the percentage of obstruction cleaned off the sensor 20 with each cleaning cycle, which provides a level of confidence for the system performance. The results of the before and after cleaning comparisons also provide data on how efficient a cleaning cycle is, and if there is improvement in repeating a cleaning cycle. If no improvement is made after repeating the cleaning cycle, then other appropriate corrective action, for example, an alarm or a request for a manual intervention, can be made.

At step 140 solvent is sprayed from the solvent nozzle onto the sensor while moving the shutter from the second position to the first position. In an embodiment, at step 150, air is sprayed from the air nozzle onto the sensor 20 while moving the shutter from the first position to the second position. In an embodiment, at step 160 a second image of the calibration mark 60 is acquired with the sensor 20, and the second image is compared with a stored image of the calibration mark. In an embodiment at step 170, a determination is made as to whether the comparison of the second image with the calibration mark indicates that the sensor 20 is clean or dirty. If the sensor 20 is clean, then at step 175 the shutter 30 is moved from the second position D to the first position A and the method 100 ends. If the sensor 20 is dirty, then step 180 repeats steps 140 to 170. Steps 140 to 170 can be repeated as many times as necessary to completely clean all debris off of the sensor 20. The next check for debris on the sensor 20 could be determined via the controller 55 by passage of time or other diagnostic for determining the veracity of the data collected by the sensor 20, or by a manually triggered cleaning request via the user interface 55, whereupon the method 100 starts again at step 110.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity. Unless otherwise noted, the use of the words “approximate,” “about,” “around,” “substantially,” etc., mean plus or minus ten percent.

### INDUSTRIAL APPLICABILITY

A system determines whether a sensor mounted on a vehicle surface is fouled by debris, and if so, the system cleans the sensor with a solvent spray and dries the sensor with an air spray. The system can be manufactured in industry for use on vehicles purchased by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

I claim:

1. A sensor cleaning system, comprising:
a shutter having a first position outside of a field of view of the sensor and a second position blocking the field of view of the sensor;
a solvent nozzle disposed on a side of the shutter facing the sensor and configured to spray solvent onto the sensor;
an air nozzle disposed on the side of the shutter facing the sensor and configured to spray air onto the sensor.

2. The sensor cleaning system of claim 1, wherein the shutter is configured to move back and forth between the first and second positions, wherein the solvent nozzle is configured to spray solvent on the sensor while the shutter moves from the second position to the first position, and wherein the air nozzle is configured to spray air on the sensor while the shutter moves from the first position to the second position.

3. The sensor cleaning system of claim 1, wherein the shutter is configured to move back and forth between the first and second positions, wherein an edge of the shutter moves across the field of view of the sensor when the shutter moves from the first position to the second position, and wherein the solvent and air nozzles are proximate to the edge of the shutter.

4. The sensor cleaning system of claim 1, wherein the shutter comprises a calibration mark disposed on the side of the shutter facing the sensor.

5. A method for applying the cleaning system of claim 1, the method comprising the steps of:
a) receiving a cleaning command from a controller with the shutter in the first position;
b) moving the shutter from the first position to the second position;
c) acquiring a first image with the sensor of a calibration mark disposed on the side of the shutter facing the sensor with the shutter in the second position, and comparing the first image with the calibration mark;
d) spraying solvent from the solvent nozzle onto the sensor while moving the shutter from the second position to the first position;
e) spraying air from the air nozzle onto the sensor while moving the shutter back to the second position from the first position; and
f) acquiring a second image with the sensor of the calibration mark with the shutter in the second position, and comparing the second image with the calibration mark;
g) wherein if the comparison of the second image with the calibration mark indicates that the sensor is clean, moving the shutter back to the first position, but if the comparison of the second image with the calibration mark indicates that the sensor is not clean, then repeating steps d) through g).

6. The sensor cleaning system of claim 1, wherein the shutter in the second position is spaced from the sensor to provide a debris drainage gap therebetween.

7. The sensor cleaning system of claim 1, wherein the sensor is disposed on a vehicle body surface and the shutter is rotatably attached to the body proximate the sensor.

8. The sensor cleaning system of claim 9, wherein the shutter is recessed into the vehicle body in the first position.

9. A sensor cleaning system, comprising:
a shutter having a first position outside of a field of view of the sensor and a second position blocking the field of view of the sensor;
a solvent nozzle disposed on a side of the shutter facing the sensor and configured to spray solvent onto the sensor;
an air nozzle disposed on the side of the shutter facing the sensor and configured to spray air onto the sensor;
wherein the shutter is configured to move back and forth between the first and second positions, wherein an edge of the shutter moves across the field of view of the sensor when the shutter moves from the first position to the second position, and wherein the solvent and air nozzles are proximate to the edge of the shutter.

10. The sensor cleaning system of claim 9, wherein the solvent nozzle is configured to spray solvent on the sensor while the shutter moves from the second position to the first position, and wherein the air nozzle is configured to spray air on the sensor while the shutter moves from the first position to the second position.

11. The sensor cleaning system of claim 9, wherein the shutter comprises a calibration mark disposed on the side of the shutter facing the sensor.

12. The sensor cleaning system of claim 9, wherein the shutter in the second position is spaced from the sensor to provide a debris drainage gap therebetween.

13. The sensor cleaning system of claim 9, wherein the sensor is disposed on a vehicle body surface and the shutter is rotatably attached to the body proximate the sensor.

14. The sensor cleaning system of claim 13, wherein the shutter is recessed into the vehicle body surface in the first position.

15. A sensor cleaning system, comprising:
a shutter having a first position outside of a field of view of the sensor and a second position blocking the field of view of the sensor;
a solvent nozzle disposed on a side of the shutter facing the sensor and configured to spray solvent onto the sensor;
an air nozzle disposed on the side of the shutter facing the sensor and configured to spray air onto the sensor;
wherein the shutter is configured to move back and forth between the first and second positions, wherein an edge of the shutter moves across the field of view of the sensor when the shutter moves from the first position to the second position, and wherein the solvent and air nozzles are proximate to the edge of the shutter; and
wherein the shutter in the second position is spaced from the sensor to provide a debris drainage gap therebetween.

16. The sensor cleaning system of claim 15, wherein the shutter comprises a calibration mark disposed on the side of the shutter facing the sensor.

17. The sensor cleaning system of claim 15, wherein the sensor is disposed on a vehicle body surface and the shutter is rotatably attached to the body proximate the sensor.

18. The sensor cleaning system of claim 17, wherein the shutter is recessed into the vehicle body surface in the first position.

19. The sensor cleaning system of claim 15, wherein the solvent nozzle is configured to spray solvent on the sensor while the shutter moves from the second position to the first position, and wherein the air nozzle is configured to spray air on the sensor while the shutter moves from the first position to the second position.

20. A method for applying the cleaning system of claim 19, the method comprising the steps of:
a) receiving a cleaning command from a controller with the shutter in the first position;
b) moving the shutter from the first position to the second position;
c) acquiring a first image with the sensor of a calibration mark disposed on the side of the shutter facing the sensor with the shutter in the second position, and comparing the first image with the calibration mark;
d) spraying solvent from the solvent nozzle onto the sensor while moving the shutter from the second position to the first position;
e) spraying air from the air nozzle onto the sensor while moving the shutter back to the second position from the first position; and
f) acquiring a second image with the sensor of the calibration mark with the shutter in the second position, and comparing the second image with the calibration mark;
g) wherein if the comparison of the second image with the calibration mark indicates that the sensor is clean, moving the shutter back to the first position, but if the comparison of the second image with the calibration mark indicates that the sensor is not clean, then repeating steps d) through g).
